(19) United States
(12) Patent Application Publication
(10) Pub. No.: US 2019/0278639 A1
(43) Pub. Date: Sep. 12, 2019

(54) SERVICE FOR ENABLING LEGACY MAINFRAME APPLICATIONS TO INVOKE JAVA CLASSES IN A SERVICE ADDRESS SPACE

(71) Applicant: CA, Inc., New York, NY (US)

(72) Inventors: Ronald James Colmone, Arlington Heights, IL (US); Jordan Dale Hisey, Schaumburg, IL (US); Narender Eshwar Sajnani, Secunderabad (IN)

(21) Appl. No.: 15/916,579

(22) Filed: Mar. 9, 2018

(51) Int. Cl. G06F 9/54; G06F 9/455; G06F 9/448; G06F 9/50

(52) U.S. Cl. CPC G06F 9/547; G06F 9/45504; G06F 2209/509; G06F 9/5005; G06F 9/4488

(57) ABSTRACT

A service is disclosed which allows a generic bridge between legacy mainframe applications and the features and functionality of a JVM without compromising platform integrity in a mainframe environment. A request manager and queues are instantiated in a legacy address space to manage offload of requests from threads of the legacy mainframe application to the service. The translating components in the service address space include a Java native interface (JNI) and a core set of functions for managing a JVM (e.g., creation and termination of threads), datatype conversion between native elements and Java programming language classes, and to ensure environment compatibility. Utilizing the service, the legacy mainframe application is able to load a Java class, instantiate new instances of Java objects, call static or instance methods of a Java class, and manage Java objects and their associated memory.

### BACKGROUND

The disclosure generally relates to the field of data processing, and more particularly to interprogram communication or interprocess communication (ipc).

In modern computing, what constitutes a mainframe system has become somewhat ambiguous. They share many characteristics with personal computers and servers, such as possessing processors, random access memory (RAM), and storage in some form. Mainframe systems, however, are typically optimized (with both hardware and software) for handling large-scale computing, such as bulk data processing and managing a large number (e.g., thousands) of concurrent sessions. Typically, the operating system of a mainframe system is tailored operating systems designed for these large-scale computing requests (requests may also be referred to as tasks, messages, or work items).

The Java® programming language is used over a multitude of platforms by many developers. For this reason, it is often used for cross-platform communications. It is possible to run a Java virtual machine (JVM) over a Java Native Interface (JNI) implementation for the hosting platform, which allows some level of the language's functionality to be used.

### BRIEF DESCRIPTION OF THE DRAWINGS

Embodiments of the disclosure may be better understood by referencing the accompanying drawings.

FIG. 1 depicts an example Mainframe to Java (“M2J”) Service which provides a generic bridge between legacy mainframe applications and a JVM without compromising platform integrity.

FIG. 2 depicts a flowchart with example operations for offloading a request from a legacy application to a JVM.

FIG. 3 depicts a flowchart with example operations for processing requests received from a legacy application.

FIG. 4 depicts an example computer system with an M2J Service.

### DESCRIPTION

The description that follows includes example systems, methods, techniques, and program flows that embody embodiments of the disclosure. However, it is understood that this disclosure may be practiced without these specific details. For instance, this disclosure refers to offloading requests within a mainframe environment such as zOS or alternate mainframe operating systems, such as the Linux operating system for mainframes. Aspects of this disclosure can be also applied to offloading requests to other computing environments and operating systems, memory systems, database systems, servers, etc. In other instances, well-known instruction instances, protocols, structures and techniques have not been shown in detail in order not to obfuscate the description.

Overview

While specific JNI implementations in combination with shared memory of a mainframe facilitates delegation of specific requests (e.g., offloading) from a native mainframe application to a JVM, the specific JNI implementations are insufficient as a generic request bridge between legacy mainframe applications and the Java environment. In addition, many mainframe applications are designed to address nontrivial security and platform integrity concerns. Mainframe operating systems address some security and platform integrity concerns by isolating applications running on the mainframe operating system within their own address spaces and indicating whether a program is an authorized or unauthorized program. With a tailored offload solution, a JVM can be instantiated within an designated address space or the specific configuration for that offload solution. However, a generic bridging solution cannot presume that the JVM can be run as an authorized program.

To provide a generic bridge between native mainframe applications and the features and functionality of a JVM without compromising platform integrity, bridging or translating components are used to manage and use a mainframe to a Java environment translation service (“M2J Service”). A legacy mainframe application (“legacy application”) instantiates the M2J Service with a natively defined function invoked from the legacy application's address space (“legacy space”). The legacy application instantiates the M2J Service in unauthorized address space to allow the M2J Service to operate in a separate environment from the authorized address space of the legacy application. The legacy application may be designated as a supervisor of the unauthorized address space. A request manager and queues are instantiated in the legacy space to manage offload of requests from threads of the legacy application to the M2J Service and allow asynchronous communications. The translating components in the M2J Service address space (“service space”) include a Java native interface (JNI) and a core set of functions for managing a JVM of the M2J Service (e.g., creation and termination of threads), datatype conversion between native primitive data types and Java objects or primitive data types, and to ensure environment compatibility. Utilizing the M2J Service, the legacy application is able to load a Java class, instantiate new instances of Java objects, call static or instance methods of a Java class with type signatures, manage Java objects and their associated memory, and perform exception handling.

Example Illustrations

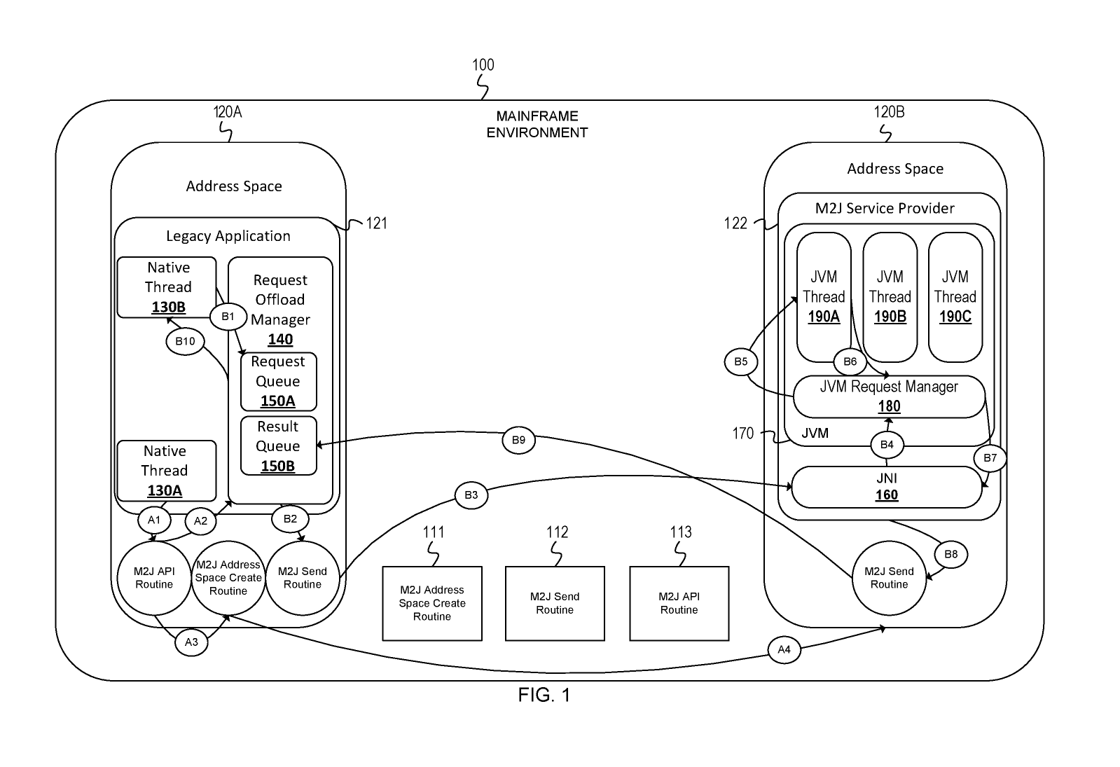

FIG. 1 depicts an example M2J Service which provides a generic bridge between legacy mainframe applications and a JVM without compromising platform integrity. In FIG. 1, a mainframe environment 100 is illustrated with address spaces 120A, 120B. The mainframe environment 100 has allocated the address space 120A to a legacy application 121. The address space 120B includes an M2J Service provider 122, a JVM 170, a JVM request manager 180, and a JNI 160. To facilitate instantiation and use of the M2J Service provider 122 by the legacy application 121, program call (PC) routines M2J Address Space Create (“M2J ASC”) 111, M2J Send routine 112, and M2J Application Programming Interface (API) 113 have been installed on the mainframe environment 100 for use by processes executing in the mainframe environment 100.

The PC routines M2J ASC 111, M2J Send 112, and M2J API 113 may be called by applications through service wrappers or macros available within address spaces of the mainframe environment 100. The PC routines may also each be assigned a unique PC number within the mainframe environment 100 which can be used to invoke the associated PC routine. Instances of the PC routines are depicted within the address spaces 120A and 120B to illustrate that these PC routines may be called or invoked from within the address spaces 120A and 120B. The instances of the PC routines within the address spaces 120A and 120B may comprise a service layer interface wrapper or a macro interface that allows threads of the legacy application 121 to invoke the functions of the PC routines and subsequently executes their code in the legacy space 120A. The M2J ASC routine 111 allocates the address space 120B within the mainframe environment 100 and causes instantiation of the M2J Service provider 122 within the address space 120B. The M2J Send routine 112 communicates requests and request results between the legacy application 121 and the M2J Service provider 122. The M2J API routine 113 allows the legacy application 121 to access API functions of the M2J Service.

The legacy application 121 is an application that runs natively within the address space 120A in the mainframe environment 100 and is based on a programming language native to the mainframe environment 100, such as C or assembly languages. When the legacy application 121 begins executing, it has at least one native thread already instantiated, which in this illustration is native thread 130A. The legacy application 121 may have one or more native threads 130 to handle various processing requests.

FIG. 1 is annotated with a series of number/letter combinations A1-A4, B1-B8, and C1-C2. These symbols represent stages of one or more operations in each stage. Although these stages are ordered for this example, the stages illustrate one example to aid in understanding this disclosure and should not be used to limit the claims. Subject matter falling within the scope of the claims can vary with respect to the order and some of the operations.

During stages A1-A4, the native thread 130A instantiates the request offload manager 140 and the M2J Service provider 122 through a series of PC routine invocations. As shown at A1, the native thread 130A invokes the M2J API routine 113 in the address space 120A. As shown in FIG. 1, an instance of the M2J API routine 113 is accessible within the address space 120A to facilitate routing of requests or function invocations from the legacy application 121 through the PC routines executing as part of the mainframe environment 100 to the M2J Service provider 122. The M2J API routine 113 includes functions/requests for initializing the request offload manager 140 and beginning, ending, and resetting the M2J Service provider 122. Other functions may be available for creating/destroying threads within the JVM 170, manipulating objects and static methods within the JVM 170, retrieving diagnostic information from the JVM 170, or managing memory allocated to the M2J Service provider 122. During stage A1, the native thread 130A calls a function through the instance of the M2J API routine 113 in the legacy space 120A for initializing the request offload manager 140 and the M2J Service 122.

At stage A2, in response to the invocation made by the native thread 130A at stage A1, the M2J API routine 113 instantiates a request offload manager 140 within the legacy application 121. The M2J API routine 113 instantiates the request offload manager 140 as a native thread which serves as a request offload manager for the other native threads 130. Various parameters may be defined to control functionality of the request offload manager 140. For example, the request offload manager 140 may be configured to perform synchronous queueing or asynchronous queueing.

At stage A3, also in response to the native thread 130A invoking a function for initializing the M2J Service, the M2J API routine 113 invokes the M2J ASC routine 111 in the legacy space 120A. In response, at stage A4, the M2J ASC routine 111 requests allocation of the address space 120B and instantiates the M2J Service provider 122 with the JVM 170. The M2J ASC routine 111 can send a request to a service of the mainframe environment 100 to allocate the address space 120B and may also request that the address space 120B be associated or allied with the address space 120A containing the legacy application 121. The address space 120B is isolated from the address space 120A to ensure that the JVM 170 does not gain access to privileged services which may be accessible from within the address space 120A. However, the address space 120B still operates within a same security context (e.g., using same credentials) as the address space 120A. In some implementations, the legacy application 121 or the address space 120A may be limited to one instantiation of the M2J Service provider 122. If another request is received to instantiate the M2J Service provider 122 for the address space 120A, the M2J ASC routine 111 determines that the address space 120B is already associated with the address space 120A and rejects the request.

During stages B1-B10, a request is processed through the M2J Service provider 122. At stage B1, a native thread 130B sends a request to the request queue 150A. The request may be a data object, Java method invocation, etc. The native threads 130 can access and queue a request in the request queue 150A. The request queue 150A may include a number of requests waiting to be sent for processing by the JVM 170.

At stage B2, once the request has reached the front of the request queue 150A, the request offload manager 140 invokes the M2J Send routine 112 in the address space 120A to offload the request to the JVM 170. As part of processing the request, the request offload manager 140 may analyze data fields in the request and capture a list of arguments from the request. The list of arguments contains for each argument a triple of the address (e.g. an identifier or a pointer for the argument), length, and type of each argument (e.g. signature resolution for data types). The request offload manager 140 can store the request and any associated data objects in shared memory of the mainframe environment 100. The request offload manager 140 can then pass an indication of the request (e.g. an identifier or a pointer for the request) to the M2J Send routine 112 to communicate that the request is to be sent for processing by the JVM 170. At stage B3, in response to receiving an indication of the request, the M2J Send routine 112 sends the request or the indication of the request to the M2J Service provider 122. The M2J Service provider 122 provides an interface to facilitate communication between the legacy application 121 and the JNI 160 and abstracts implementation details of the JNI 160 from the legacy application 121. Through interaction with the JNI 160, the M2J Service provider 122 provides instructions to the JVM 170 necessary to process the request within the JVM 170. The M2J Service provider 122 also maps requests which include native data types to the corresponding JNI 160 interfaces which support those data types. For example, if the M2J Service provider 122 detects a C language “int” type data object within a request, the M2J Service provider 122 maps the data object to an interface of the JNI 160 which converts the data object to a Java “jint” data type. After receiving the request, the M2J Service provider 122 identifies an appropriate interface for the request and supplies the request or an indication of the request to the identified interface of the JNI 160.

At stage B4, an interface of the JNI 160 in the address space 120B translates the request to be compatible with the JVM 170. As described above, the JNI 160 allows for an abstract datatype conversion between data types compatible with mainframe programming languages and data types compatible with the Java programming language. The request and the translated data objects of the request, if any, are sent to a JVM request manager 180, which is a thread within the JVM 170. At stage B5, the JVM request manager 180 allocates resources and assigns a JVM thread 190A to the request. For example, if the request is a Java method call, the JVM request manager 180 may create and assign the JVM thread 190A to perform the method and load appropriate libraries and resources to facilitate performance of the Java method. In some instances, a request may necessitate multi-threaded processing, so the JVM request manager 180 may assign multiple threads 190 to process the request as indicated by the legacy caller which provided the request (i.e., the native thread 130B). The JNI 160 can also perform signature resolution for the request. In order to invoke a Java method or access a class field, a parameter signature is required. The JNI 160 may generate a signature which follows the Java Virtual Machine Type Signatures representation and is compatible with a method being invoked for the request. The JNI 160 may store generated signatures in cache or memory for subsequent reuse.

At stage B6, after the JVM thread 190A processes the request, the JVM thread 190A notifies the JVM request manager 180 that processing is complete. At stage B7, the JVM request manager 180 sends the request through the JNI 160 for translation of data objects back to the native data types as needed. The JNI 160 translates the request as necessary and passes the request to the M2J Service provider 122 or otherwise notifies the M2J Service provider 122 that the request is complete. The M2J Service provider 122 captures data objects returned as a result of processing the request and stores the data objects in shared memory. The returned data objects or pointers to the data objects are incorporated into the response. At stage B8, the M2J Service provider 122 invokes the M2J Send routine 112 in address space 120B to send the request to the result queue 150B. The M2J Service provider 122 may also place the request in shared memory of the mainframe environment 100 with the processed request or create an entry with data generated as a result of processing the request.

At stage B9, the M2J Send routine 112 sends the processed request to the result queue 150B. At stage B10, once the request reaches the front of the result queue 150B, the request offload manager 140 notifies native thread 130B it has been processed. This notification includes an indicator of the processed request in shared memory, allowing the native thread 130B to access the data results of its request. The request offload manager 140 may be programmed to check the result queue 150B upon receiving a notification that a processed request has been placed in the result queue 150B. To return the request to the native thread 130B, the request offload manager 140 may provide an identifier or pointer for the processed request which allows the native thread 130B to access the processed request in the result queue 150B or shared memory.

If an error is encountered (e.g. JVM exceptions or service provider errors) during processing of the request, it may either be handled by the M2J Service provider 122 or passed to the native thread 130B which can invoke a function to take ownership of the error and acknowledge receipt of the exception. The native thread 130B may also invoke a function of the M2J API routine 113 to retrieve diagnostic information from the JVM 170 related to the processing of the request. Based on the error, the native thread 130B may again provide the request to the request offload manager 140 for another processing attempt. In some instances, the native thread 130B may also invoke a function to reset the M2J Service provider 122 in order to allow additional requests to be supported. If a JVM exception is not addressed, the M2J service provider 122 will terminate upon receiving a subsequent legacy request.

After use of the JVM 170 is complete, the legacy application 121 may invoke a function in the M2J API routine 113 to reduce an amount of memory space allocated to the M2J Service provider 122, terminate a thread of the JVM 170 or, if no longer needed, invoke a function to terminate the M2J Service provider 122 and deallocate the address space 120B.

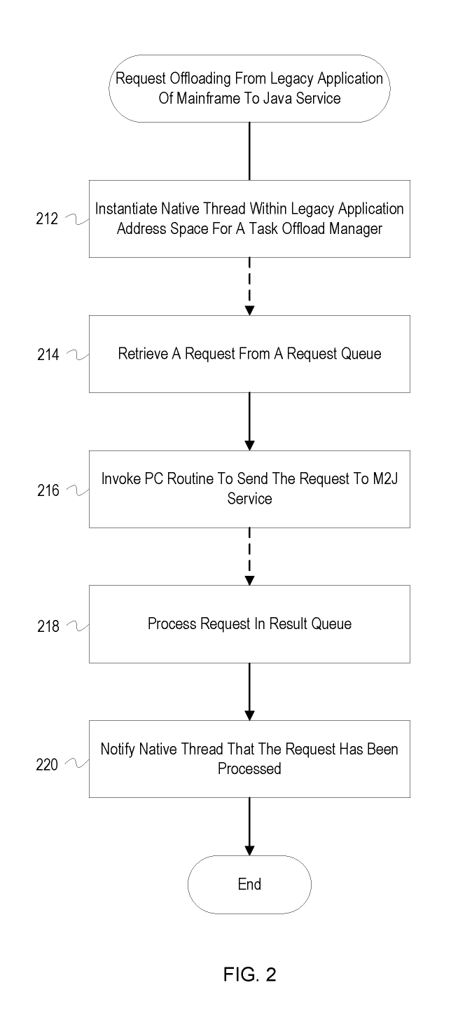

FIG. 2 depicts a flowchart with example operations for offloading a request from a legacy application to a JVM. FIG. 2 describes a request offload manager as performing the operations for naming consistency with FIG. 1, although naming of program code can vary among implementations. FIG. 2 uses dashed lines to depict asynchronous flow or responses between operations.

A request offload manager is instantiated within a native thread in a same address space as a legacy application (212). The request offload manager manages the offloading of requests from other native threads of the legacy application which request processing of Java requests. The request offload manager may be instantiated in response to a request from the legacy application to initiate an M2J Service. For example, a PC routine or macro of the M2J Service may instantiate the request offload manager to facilitate communication with the M2J Service.

The request offload manager retrieves a request from a request queue (214). Native threads within the address space of the request offload manager can send requests to the request queue for processing by a JVM of the M2J Service. In some implementations, requests for offloading may be communicated directly to the request offload manager. However, since a legacy application may have multiple threads submitting requests for offloading, using a queue allows for asynchronous processing of the requests to be offloaded and prevents the request offload manager from being a bottleneck. The request offload manager may periodically check the request queue for new requests and continue processing requests in the queue as described below until the queue is empty. As part of preparing the request to be sent to the M2J Service, the request offload manager may perform data field processing on the request to generate a list of arguments which includes a triple for each argument including an address, length, and type. The request offload manager may also move data for the request from the request queue or memory within the legacy address space to anchored or shared memory of the mainframe. Anchored memory refers to connected areas of shared memory that allows for data to be passed between address spaces. Data stored in anchored memory may be associated with an identifier or pointer that allows for the data to be retrieved from the shared memory as well as a list of arguments containing triples of address, length and type. This cross-memory communication and retrieval of data from shared memory may be facilitated by the use of an event control block (“ECB”) or a pause element (PE).

The request offload manager invokes a PC routine to send the queued request to the M2J Service provider (216). The PC routine may be a mainframe routine such as the M2J Send routine which facilitates communication between the request offload manager in the legacy address space and an M2J Service executing in a service address space. To send the queued request, the request offload manager may provide the PC routine with an identifier or pointer to the request stored in shared memory. Sending an indicator for the request as opposed to transmitting the data for the request between address spaces reduces cross-communication overhead and transmission time. The PC routine then passes the request or an identifier for the request to the M2J Service for processing.

As indicated by the dashed line connecting blocks 216 and 218 in FIG. 2, the operations for offloading a request to the M2J Service and then receiving a result may be asynchronous. During this period, the request offload manager may continue processing requests from the request queue by offloading them to the M2J Service. Similarly, the M2J Service may have its own queue from which it processes requests in the order which they were received. Once a request has been processed, the M2J Service may update anchored memory with the results of processing the request. The M2J Service also invokes a PC routine to transmit the completed request or an indicator for request to a result queue of the request offload manager.

The request offload manager processes requests in the result queue (218). Similar to the request queue, the request offload manager may monitor the result queue or periodically check the result queue to determine if requests have been added. If the result queue contains new processed requests, the request offload manager iteratively processes the requests in the queue. As described above, the result queue may not contain data of a processed request but, rather, an identifier or pointer to the request data in anchored memory. In some implementations, the request offload manager processes the requests in the result queue by using the identifier or pointer to read the request data from anchored memory and move the request data into memory of the legacy address space. In instances where an error (e.g. a Java exception) is encountered while processing a request, the M2J Service may load an error message or other notification in the result queue.

The request offload manager notifies the native thread from which the request originated that the request has been processed (220). In instances where a data object is returned, the request offload manager provides the data object to the native thread. In some implementations, the request offload manager provides a pointer to the data object in memory of the legacy address space or an identifier for retrieving the data object from anchored memory. In some instances, a request may not have data to be returned, so the request offload manager just indicates that the request was performed. After notifying the native thread that the request has been processed, the process ends, and the request is considered complete.

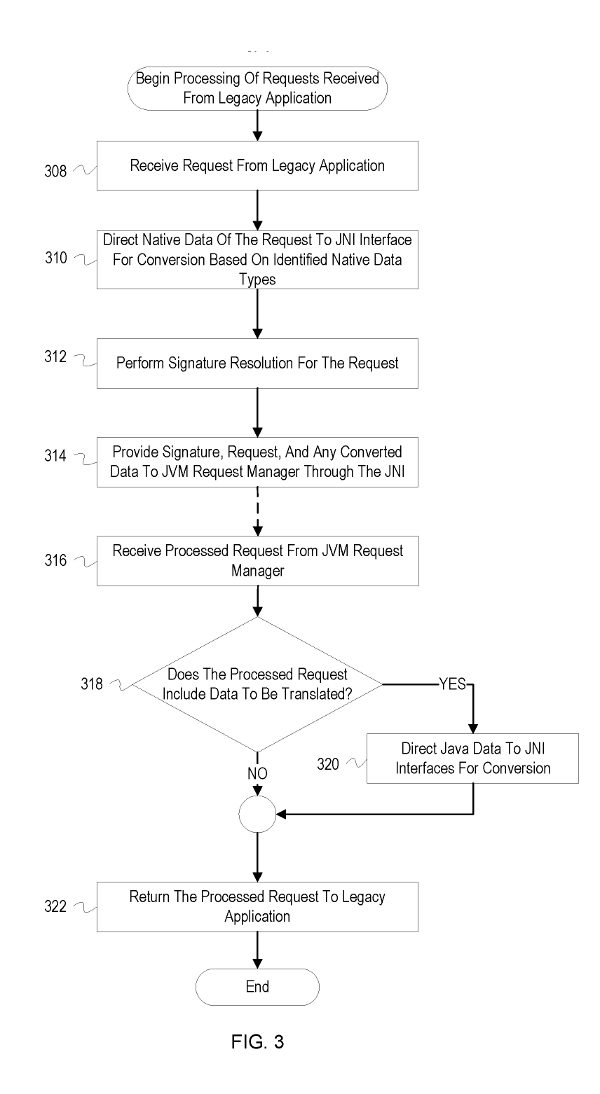

FIG. 3 depicts a flowchart with example operations for processing requests received from a legacy application. FIG. 3 describes an M2J Service provider as performing the operations of FIG. 3 for naming consistency with FIG. 1, although naming of program code can vary among implementations. The M2J Service provider is a process in a service address space that is instantiated by a legacy application to carry out the operations of FIG. 3.

The M2J Service provider receives a request from a legacy application (308). This can be a request sent from a native thread in the legacy application through a request offload manager as detailed in FIG. 2, 212-218.

The M2J Service provider directs native data of the request to a corresponding JNI interface based on the identified native datatypes (310). The request may be a data object to be instantiated, a function call to a Java library method, or an invocation of a user-defined Java method. The data object or data provided as parameters to the function calls may be of native data type which is incompatible with the Java environment. The M2J Service provider analyzes the request's data and determines whether any of the data should be converted to Java data types. For example, the M2J Service provider determines that data should be converted if a parameter of a Java method being invoked specifies that a Java data type, such as a string, is utilized in the method. The M2J Service directs the native data to the corresponding interface of the JNI designed to convert the determined native data type to a Java data type. In some instances, converting the data may involve one or more calls to JNI interfaces, memory allocation for the data to be converted, and return of the converted data or a pointer to the converted data to the M2J Service provider. This approach to data conversion abstracts the burden of ensuring data compatibility with the JVM from the legacy application by allowing the conversion of native data types to a functionally similar Java data type by the M2J Service provider.

The M2J Service provider performs signature resolution for the request (312). Signature resolution is required to invoke a Java method or access a class field. The M2J service maps primitive data types to their corresponding Java signature values. For example, a native data type “int” maps to a signature value of “I,” and a native data type of “char” maps to a signature value of “C.” For some primitive data types, additional processing may be required to generate a signature, such as performing operations to obtain a qualified class name. This signature in combination with a method name supplied in the request are used to identify the method that the M2J Service provider will invoke.

The M2J Service provider provides the signature, request and any converted data to a JVM request manager through the JNI (314). Once any native data has been converted, the M2J Service provider can provide the request for processing within a JVM. The request is delivered to the JVM through the JNI.

The M2J Service provider receives the processed request from a JVM request manager (316). As indicated by the dashed line in FIG. 3, the response from the JVM request manager may be asynchronous.

The M2J Service provider determines if the processed request includes data to be translated (318). In some instances, a native thread which submitted a request for processing may not need to access data from a processed request. The native thread can indicate that the data will not be accessed by, for example, declaring the return data type for an invoked Java method as data type “object”. The “object” data type causes a reference/pointer to the data to be returned and avoids the exposure of java objects to the legacy environment. The native thread can use the pointer to the data as an argument on subsequent method calls to reference the returned data. However, if the indicated returned values for a processed request indicate data types such as strings, integers, or other Java data types, the returned data can be translated into native data types.

If the processed request includes data for translation, the M2J Service provider directs the Java data to the corresponding JNI interface for conversion (320). In some instances, when converting Java data back to native data, the M2J Service provider may choose an appropriate data type for conversion based on criteria such as a native language of the legacy application or a length or size of data being returned. For example, if the legacy application uses C as its native language, the M2J Service provider converts the returned Java string to the string format requested by the legacy application (e.g. a string, fixchar, varchar, or lvarchar).

If the request does not include data for translation or after translating the request data, the M2J Service provider returns the processed request to the legacy application (322). To return the processed request, the M2J Service provider may store the returned request data in anchored memory of the mainframe environment. The M2J Service provider then invokes a PC routine to route the request data or an indication of the request data to a request offload manager of the legacy application or to a results queue associated with the request offload manager. The request offload manager then returns the request to the native thread of the legacy application which initially requested the M2J Service as detailed in FIG. 2, 218-220.

In addition to the disclosure above, a number of functions may be used to facilitate an M2J Service. These functions may be called by a legacy application in a legacy space on a mainframe. Various data structures may be used to hold arguments or results for these functions. These data structures may specify pertinent information such as a handle for the M2J Service, environmental variables, or data types. It may also be beneficial to specify “private” data structures which are not available to the legacy application. These data structures may pertain to thread instantiation or caching method or object types for the JVM and may be used by the M2J Service provider. Additionally, as with any computer code, function names do not necessarily reflect function. The following function definitions are intended to illustrate aspects of an M2J Service, but their exact names or functions are not intended to limit the capacities of such a service.

The functions may be divided into six groups, namely those functions which pertain to initializing the M2J Service, to JVM control, to JVM thread management, to object management, to method invocation, and to exception handling and diagnostics. Several of these functions should be called in an appropriate sequence. For example, if the M2J Service is not initialized, JVM threads cannot be managed.

In the first group of functions (those which pertain to the M2J Service as a whole) two functions may be defined. These are the M2JInit and the M2JTerm functions.

The M2JInit function may be defined to initialize the M2J Service. The M2JInit function has four parameters: a handle for the M2J Service, an integer specifying a coded character set identifier (“CCSID”), an integer specifying the number of environment variables, and an array of environment variables. Each entry in the array specifies a name and value pair for variable initialization. The M2J Service supports conversion of CCISD encoded character-based data to Unicode encoded character-based data for compatibility with JVMs. Conversely, as data is returned from a JVM to a legacy application, the M2J Service supports translating the Unicode character-based data to CCISD encoding.

The M2JTerm function may be defined to terminate the M2J Service. The M2JTerm function has one parameter: the handle of the M2J Service.

In the second group of functions (those which pertain to controlling the JVM) four functions are defined. These are the M2JCreateJVM, M2JDestroyJVM, M2JResetJVM, and M2JQueryJVM functions.

The M2JCreateJVM function may be defined to create the Java environment and launch the JVM with the specified arguments. The M2JCreateJVM function has two parameters: the handle of the M2J Service and a string specifying arguments to be passed to the JVM.

The M2JDestroyJVM function may be defined to destroy the Java environment and JVM. The M2JDestroyJVM function has one parameter: the M2J Service handle.

The M2JResetJVM function may be defined to destroy the existing JVM and initialize a new JVM with a persistent handle. The M2JResetJVM function has one parameter: the M2J Service handle. This function is intended to return the JVM to its initial state.

The M2JQueryJVM function may be defined to obtain the JVM version and runtime environment prior to calling the M2JCreateJVM function. The M2JQueryJVM function has four parameters: the M2J Service handle, address mode specification, and optionally two strings which may be used to specify minimum and maximum JVM version allowances. For example, certain methods may be desired which were introduced in JVM version “X” and removed in JVM version “Y”. Any JVM version released before X or after Y is then unacceptable. Specifying versions X and Y will allow a quick check of environment suitability. For example, in zOS the C runtime environment may be either a 64-bit or a 31-bit environment. The runtime environment should match the JVM; that is, a 64-bit JVM should be used with a 64-bit C runtime environment and a 31-bit JVM should be used with a 31-bit C runtime environment. If a runtime environment mismatch is discovered, the runtime environment is terminated and restarted as a compatible runtime environment.

In the third group of functions (those which pertain to JVM thread management) two functions are defined. These are the M2JCreateThread and the M2JDestroyThread functions.

The M2JCreateThread function may be defined to assign additional threads to the JVM. The M2JCreateThread function has two parameters: the M2J Service handle and an integer specifying thread ID. Recall that thread zero is assigned by the M2JCreateJVM function.

The M2JDestroyThread function may be defined to relinquish a thread assigned to the JVM. The M2JDestroyThread function has two parameters: the M2J Service handle and an integer specifying thread ID. This may be accomplished in three stages by releasing JVM memory associated with the specified thread, detaching the thread from the JVM, and then releasing memory associated with the thread.

In the fourth group of functions (those which pertain to object management) two functions may be defined. These are the M2JNew and the M2JDelete functions.

The M2JNew function may be defined to instantiate a new Java object. The M2JNew function accepts nine parameters: the M2J Service handle, two integers specifying CCSID and thread ID, object type, the class of the object, return field for the object, an integer specifying an array length as well as an array with objects as entries, and an optional integer which specifies the address of another integer whose length is equal to the length of the data provided to the caller.

The M2JDelete function may be defined to terminate an instantiated Java object. The M2JDelete function has three parameters: the M2J Service handle, an integer specifying which thread to delete an item from, and a specification of the object to be terminated.

In the fifth group of functions (those which pertain to method invocation) one function may be defined. This is the M2JInvokeMethod function.

The M2JInvokeMethod function may be defined to invoke a method of a class, static or an instance in the JVM and generate a method signature. This signature in combination with the legacy caller's supplied method name are used to identify the proper method that the service provider will invoke. The M2JInvokeMethod function has ten parameters: the M2J Service handle, two integers specifying the thread to invoke a method for string conversions on and a CCSID, the name of the class being called, a java object to be passed to the instantiated method, the name of the called method and the return field to return the called methods' return value, an optional integer which is an address where the length of the data provided to the caller is returned, an integer specifying the number of arguments to be passed to the called method, and an array of arguments to be passed to the method.

In the sixth group of functions (those which pertain to exception handling and diagnostics) two functions are defined. These are the M2JResetException and the M2JGetDiagnostics functions.

The M2JResetException function may be defined to clear a JVM exception which has previously occurred. The M2JResetException function has two parameters: the M2J Service handle and a thread ID. This function is intended to allow the legacy application to acknowledge the thrown exception and clear the exception condition within the JVM thus allowing subsequent calls to be serviced by the JVM. If the legacy application fails to acknowledge and take ownership of the exception, the M2J Service may terminate the JVM upon a subsequent request received from the legacy application.

The M2JGetDiagnostics function may be defined to obtain diagnostic information on the immediately prior M2J function call. The M2JGetDiagnostics function has seven parameters: the M2J Service handle, two integers specifying thread ID and CCSID, a datatype specification for what was to be returned in the native language, an optional address of the return buffer, an integer specifying the length of the return buffer, and an optional integer specifying the address of an integer which is the length of the data provided to the caller. An “M2JDIAG” data structure may be defined and used to return diagnostic information from the M2JGetDiagnostics function, which would allow the construction of more complex diagnostic analysis on a case-by-case basis.

Each of the above functions may return one or more of an integer, string, array, pointer, Boolean, object or other data structure as part of their designated functions. For example, as described above, the M2JGetDiagnostics function returns diagnostic information which may be in the form of a string data object. Some of the functions may return a Boolean value indicating whether the function was successfully performed.

In FIG. 1, the M2J API PC routine is called by a native thread. From the perspective of a caller in the legacy application, one would not need to explicitly demand the M2J API routine; the caller in the legacy application could instead make one of the function calls detailed above, such as M2JInit. At this point M2JInit would use its arguments to appropriately initialize an M2J Service. A function call to the M2JCreateJVM function may come next, followed by one or several M2JCreateThread calls. At this point, the caller in the legacy application would have access to the M2J Service with a JVM with as many threads as requested.

Variations

Although described as executing within a mainframe environment, some or all of functions the M2J Service can be instantiated outside of the mainframe environment such as on a server in communication with the mainframe. For example, it is possible to instantiate the M2J Service on a device in a same network as the mainframe which communicates with the legacy application via the TCP/IP protocol. The M2J Service executing on a server could facilitate offloading of requests for legacy applications of several different mainframes in a network.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 218 and 220 can be performed in parallel or concurrently. With respect to FIG. 3, block 310 may not be performed in some instances. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

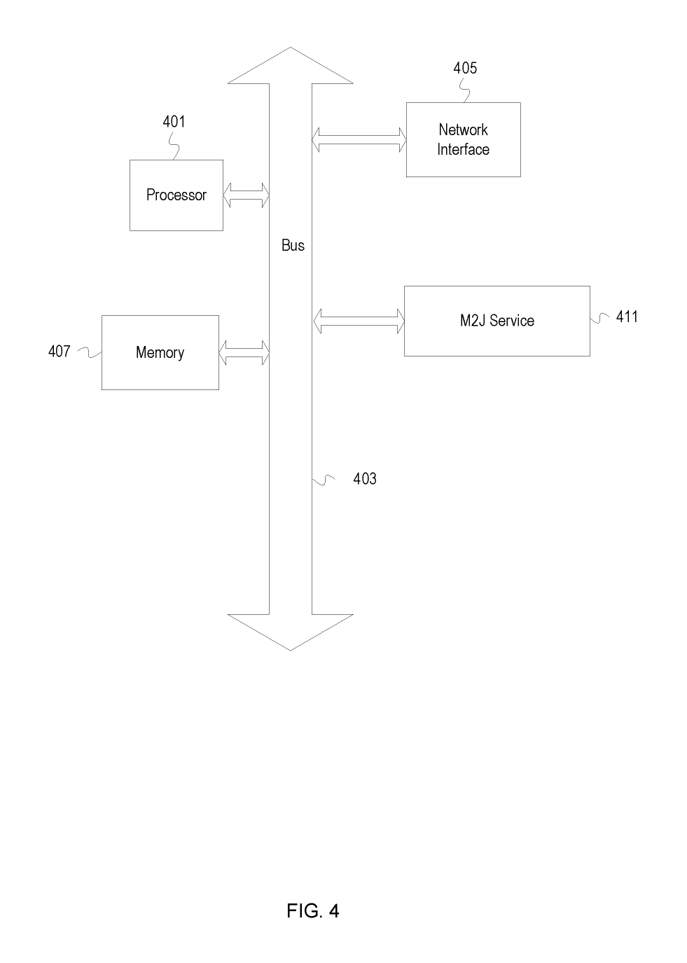

FIG. 4 depicts an example computer system with an M2J Service. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes the M2J Service 411. The M2J Service 411 provides a generic bridge between legacy mainframe applications and a JVM without compromising platform integrity. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for enabling legacy mainframe applications to invoke Java classes in a service address space as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
establishing, in a first address space for a native application in a mainframe environment, an offloading thread that monitors a first queue for requests offloaded from one or more threads of the first address space;
instantiating a Java service in the mainframe environment for access by the native application, wherein instantiating the Java service comprises,
allocating a second address space for a Java Virtual Machine (JVM) and a Java Native Interface (JNI);
instantiating in the second address space the JVM, the JNI, and an interface of the Java service that routes requests to the JVM through the JNI;
for each request detected in the first queue by the offloading thread in the first address space,
the offload thread communicating the request from the first address space to the Java service;
the Java service passing the request to the JVM through the JNI and communicating a result of the request from the JNI after processing by the JVM back to the offloading thread; and
the offloading thread communicating the result of the request to a thread which originated the request.

2. The method of claim 1, wherein allocating the second address space for the JVM and the JNI comprises requesting creation of the second address space as an unauthorized address space with a designation of the native application as a supervisor.

3. The method of claim 1, wherein the Java service passing the request to the JVM through the JNI comprises:
identifying first data in the request which is of a data type native to the mainframe environment;
identifying an interface of the JNI for conversion of the first data to a data type compatible with the JVM; and
converting the first data using the interface of the JNI.

4. The method of claim 1, wherein the Java service passing the request to the JVM through the JNI comprises generating a Java signature for the request, wherein the Java signature comprises Java data type values and a Java method name indicated in the request.

5. The method of claim 1, wherein the offloading thread communicating the result of the request to the thread which originated the request comprises:
retrieving the result from shared memory of the mainframe environment;
storing the result in memory of the first address space; and
communicating an identifier for the result stored in the memory of the first address space to the thread which originated the request;
wherein the Java service communicating the result of the request from the JNI after processing by the JVM back to the offloading thread comprises moving the result from the second address space into the shared memory of the mainframe environment.

6. The method of claim 1, wherein each request comprises an identifier of the thread which originated the request.

7. The method of claim 1, wherein communicating the request from the first address space to the Java service comprises:
identifying a program call routine available within the mainframe environment; and
invoking the program call routine from within the first address space to send the request to the Java service.

8. The method of claim 7, wherein the program call routine is invoked through an interface within the first address space which is in a program code compatible with the native application.

9. The method of claim 1 further comprising the Java service:
determining that the result of the request is an exception thrown by the JVM;
passing the exception through the offloading thread to the thread which originated the request; and
upon determining that the thread has not acknowledged the exception, terminating the JVM.

10. One or more non-transitory machine-readable media comprising program code, the program code to:
establish, in a first address space for a native application in a mainframe environment, an offloading thread that monitors a first queue for requests offloaded from one or more threads of the first address space;
instantiate a Java service in the mainframe environment for access by the native application, wherein the program code to instantiate the Java service comprises program code to,
allocate a second address space for a Java Virtual Machine (JVM) and a Java Native Interface (JNI); and
instantiate in the second address space the JVM, the JNI, and an interface of the Java service that routes requests to the JVM through the JNI; and
for each request detected in the first queue by the offloading thread in the first address space,
communicate, by the offloading thread, the request from the first address space to the Java service;
pass, by the Java service, the request to the JVM through the JNI;
communicate, by the Java service, a result of the request from the JNI after processing by the JVM back to the offloading thread; and
communicate, by the offloading thread, the result of the request to a thread which originated the request.

11. The machine-readable media of claim 10, wherein the program code to pass, by the Java service, the request to the JVM through the JNI comprises program code to:
identify first data in the request which is of a data type native to the mainframe environment;
identify an interface of the JNI for conversion of the first data to a data type compatible with the JVM; and
convert the first data using the interface of the JNI.

12. An apparatus comprising:
a processor; and
a machine-readable medium having program code executable by the processor to cause the apparatus to,
establish, in a first address space for a native application in a mainframe environment, an offloading thread that monitors a first queue for requests offloaded from one or more threads of the first address space;
instantiate a Java service in the mainframe environment for access by the native application, wherein the program code to instantiate the Java service comprises program code to,
allocate a second address space for a Java Virtual Machine (JVM) and a Java Native Interface (JNI); and
instantiate in the second address space the JVM, the JNI, and an interface of the Java service that routes requests to the JVM through the JNI; and
for each request detected in the first queue by the offloading thread in the first address space,
communicate, by the offloading thread, the request from the first address space to the Java service;
pass, by the Java service, the request to the JVM through the JNI;
communicate, by the Java service, a result of the request from the JNI after processing by the JVM back to the offloading thread; and
communicate, by the offloading thread, the result of the request to a thread which originated the request.

13. The apparatus of claim 12, wherein the program code to allocate the second address space for the JVM and the JNI comprises program code to request creation of the second address space as an unauthorized address space with a designation of the native application as a supervisor.

14. The apparatus of claim 12, wherein the program code to pass, by the Java service, the request to the JVM through the JNI comprises program code to:
identify first data in the request which is of a data type native to the mainframe environment;
identify an interface of the JNI for conversion of the first data to a data type compatible with the JVM; and
convert the first data using the interface of the JNI.

15. The apparatus of claim 12, wherein the program code to pass, by the Java service, the request to the JVM through the JNI comprises program code to generate a Java signature for the request, wherein the Java signature comprises Java data type values and a Java method name indicated in the request.

16. The apparatus of claim 12, wherein the program code to communicate, by the offloading thread, the result of the request to the thread which originated the request comprises program code to:
retrieve the result from shared memory of the mainframe environment;
store the result in memory of the first address space; and
communicate an identifier for the result stored in the memory of the first address space to the thread which originated the request;
wherein the program code to communicate, by the Java service, the result of the request from the JNI after processing by the JVM back to the offloading thread comprises program code to move the result from the second address space into the shared memory of the mainframe environment.

17. The apparatus of claim 12, wherein each request comprises an identifier of the thread which originated the request.

18. The apparatus of claim 12, wherein the program code to communicate, by the offloading thread, the request from the first address space to the Java service comprises program code to:
identify a program call routine available within the mainframe environment; and
invoke the program call routine from within the first address space to send the request to the Java service.

19. The apparatus of claim 18, wherein the program call routine is invoked through a macro within the first address space which is in a program code compatible with the native application.

20. The apparatus of claim 12 further comprising program code to:
determine, by the Java service, that the result of the request is an exception thrown by the JVM;
pass, by the Java service, the exception through the offloading thread to the thread which originated the request; and
upon a determination that the thread has not acknowledged the exception, terminate, by the Java service, the JVM.
